(19) United States
(12) Patent Application Publication
(10) Pub. No.: US 2009/0244558 A1
(43) Pub. Date: Oct. 1, 2009

(54) IMAGE PROCESSING APPARATUS AND IMAGE PROCESSING METHOD

(75) Inventors: Shunichi Megawa, Shizuoka-Ken (JP); Masaaki Yasunaga, Mishima-Shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/054,605

(22) Filed: Mar. 25, 2008

(51) Int. Cl. G06K 1/00

(52) U.S. Cl. 358/1.9

(57) ABSTRACT

An image processing apparatus according to the invention includes: an input unit configured to input first document data including bitmap data; an image component dividing unit configured to divide the first document data into components and separate the bitmap data included in the first document data; a determining unit configured to determine, in accordance with attribute information of each bitmap data acquired by the division into components, whether the bitmap data is convertible into vector data or not; and a vectorizing unit configured to convert the bitmap data that is determined as being convertible into vector data, into vector data. With the image processing apparatus according to the invention, an output with high image quality can be provided at the time of enlarging or reducing a monitor output or print output of binary bitmap data or index bitmap data.

### BACKGROUND OF THE INVENTION

1. Technical Field of the Invention

The present invention relates to an image processing technique to which monitor display or printer output of a document file is applied, and particularly to an image processing apparatus and an image processing method that enable monitor display or printer output of a document file containing plural formats of bitmap data such as PDF, XML and HTML.

2. Related Art

Document data outputted by word processing software or a drawing-based application is expressed by a set of command data including at least one of figures and characters. Characters are formed by command data of font data. Figures, free-form curves and so on are formed by command data of vector data. Images inputted by being scanned are formed by command data of bitmap data.

Characters and figures of document data outputted by word processing software or a drawing-based application are formed by vector data and therefore have smooth contours even when they are enlarged or reduced.

However, in the case of images inputted by being scanned, instead of the document data, all the images are rasterized from the command data of bitmap data. Therefore, when the images inputted by being scanned are enlarged or reduced, the contours of characters and figures appear in a jagged step-like shape and are not smooth.

Meanwhile, in the case of printer output, when inputted document data is outputted by software of a word processor or the like, image processing such as filter processing and gradation processing can be switched to be suitable for image attributes of each data in accordance with the difference among font data, vector data and bitmap data.

However, in the case of printer output, when inputted document data are images inputted by being scanned, all the document images are formed into bitmap data by page description language and therefore image processing cannot be switched in accordance with image attributes of font data, vector data, bitmap data and so on. Thus, even for characters that originally have font data, image processing for bitmap data that is the same as for natural images must be performed and a printer output of the characters with high image quality cannot be provided.

To deal with this problem, conventionally, Patent Reference 1 (JP-A-2005-182369) has been laid open.

In the preparation method described in Patent Reference 1, an input image is converted into vector data, thus making it possible to provide a printer output with a certain degree of high image quality. However, in the preparation method described in Patent Reference 1, since input images are limited to binary images, multi-value images cannot be processed. Moreover, if an image having a large number of gradation levels is converted into vector data, the processing is generally very long and deterioration in image quality may occur.

### SUMMARY OF THE INVENTION

In view of the foregoing circumstances, it is an object of the invention to provide an image processing apparatus and an image processing method that enable monitor output or printer output with high image quality.

To achieve the above object, an image processing apparatus according to an aspect of the invention includes: an input unit configured to input first document data including one or two or more bitmap data; an image component dividing unit configured to divide the inputted first document data into components and separate the bitmap data included in the first document data; a determining unit configured to determine, in the case where attribute information of each bitmap data acquired by the division into components corresponds to an attribute of predetermined attribute information, that the bitmap data is convertible into vector data; and a vectorizing unit configured to convert the bitmap data that is determined as being convertible into vector data, into vector data.

Also, to achieve the above object, an image processing method according to another aspect of the invention includes: inputting first document data including one or two or more bitmap data; dividing the inputted first document data into components and separating the bitmap data included in the first document data; in the case where attribute information of each bitmap data acquired by the division into components corresponds to an attribute of predetermined attribute information, determining that the bitmap data is convertible into vector data; and converting the bitmap data that is determined as being convertible into vector data, into vector data.

Moreover, to achieve the above object, an image processing method according to still another aspect of the invention includes: inputting first document data including one or two or more bitmap data; dividing the inputted first document data into components and separating the bitmap data included in the first document data; in the case where attribute information of each bitmap data acquired by the division into components corresponds to an attribute of predetermined attribute information, determining that the bitmap data is convertible into vector data; converting the bitmap data that is determined as being convertible into vector data, into vector data; and combining image data that is converted into vector data, image data that is not converted into vector data, and document data, to create second document data.

### BRIEF DESCRIPTION OF THE DRAWINGS

In the attached drawings,

FIG. 1 is a functional block diagram of a first embodiment of an image processing apparatus according to the invention;

FIG. 2 is a view showing an example of PDF input document data including two bitmap data;

FIG. 3 is a view showing an exemplary command set to draw each bitmap data of the input document data shown in FIG. 2;

FIG. 4 is a view showing an example of HTML input document data including two bitmap data;

FIG. 5 is a view showing an exemplary command set to draw each bitmap data of the input document data shown in FIG. 4;

FIG. 6 is a view for explaining the state of creating a binary image from an index image;

FIG. 7 is a view showing document data provided by converting a part of the bitmap data of the input document data shown in FIG. 2, into vector data;

FIG. 8 is a view showing an exemplary command set to draw vector data and each bitmap data of the document data shown in FIG. 7;

FIG. 9 is a flowchart showing the operation of the first embodiment of the image processing apparatus according to the invention;

FIG. 10 is a functional block diagram of a second embodiment of the image processing apparatus according to the invention; and

FIG. 11 is a flowchart showing the operation of the second embodiment of the image processing apparatus according to the invention.

### DETAILED DESCRIPTION OF THE PREFERRED EMBODIMENTS

Embodiments of an image processing apparatus according to the invention will be described with reference to the attached drawings.

### First Embodiment

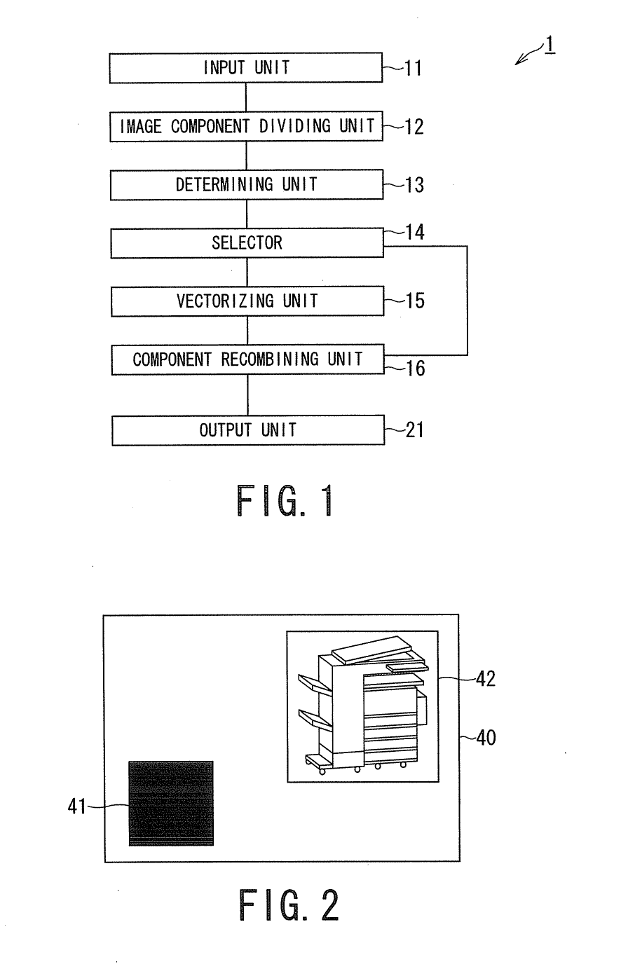

FIG. 1 is a functional block diagram of an image processing apparatus 1 according to the invention.

The image processing apparatus 1 has an input unit 11, an image component dividing unit 12 connected to the input unit 11, a determining unit 13 connected to the image component dividing unit 12, a selector 14 connected to the determining unit 13, a vectorizing unit 15 connected to the selector 14, a component recombining unit 16 connected to the vectorizing unit 15 and the selector 14, and an output unit 21.

The input unit 11 inputs first document data including one or two or more bitmap data.

The first document data is document data in a format capable of containing one or two or more bitmap data. The first document data may be, for example, the page description language (PDL) of postscript or the like, or document data having the format of PDF by Adobe, XML document, HTML document or the like.

The bitmap data included in the first document data may be data compressed by the coding method of MMR, JPEG or the like.

As a technique of including the bitmap data in the first document data, directly writing the number of bits, the number of colors, the coding method and the code stream of the bitmap data into the document data as in PS or PDF can be used. Also designating the electronic file name of the bitmap data as in HTML or XML can be used.

The image component dividing unit 12 divides the first document data inputted by the input unit 11 into components and separates the bitmap data included in the first document data. For example, in the case where two bitmap data and one document data are included in the first document data, the first document data is divided into the components, that is, the two bitmap data and one document data, and thus separated into three.

The determining unit 13 searches attribute information of each bitmap data acquired by the division into components by the image component dividing unit 12. In the case where the searched attribute information corresponds to an attribute of predetermined attribute information, the determining unit 13 determines that the bitmap data is convertible into vector data.

On the other hand, in the case where the searched attribute information does not correspond to an attribute of predetermined attribute information, the determining unit 13 determines that the bitmap data is inconvertible into vector data.

Here, the attribute information of the bitmap data refers to information such as the number of bits and the difference in image coding method.

The attribute information of the bitmap data will be described with reference to the drawings.

First, a case will be described in which document data in a format that the number of bits, the number of colors, the coding method and the code stream of bitmap data are directly written into document data, as in PS or PDF, is inputted.

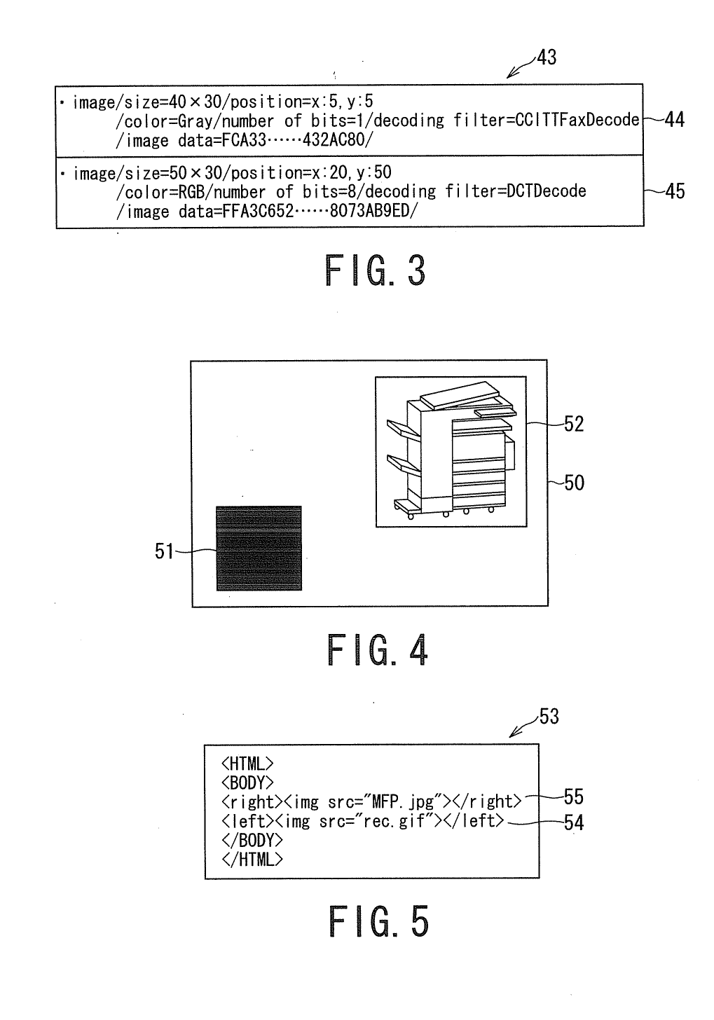

FIG. 2 shows an example of PDF input document data including two bitmap data. FIG. 3 is a view showing an exemplary command set to draw each bitmap data of the input document data shown in FIG. 2.

PDF input document data 40 shown in FIG. 2 includes two bitmap data, that is, a binary image 41 and a multi-value image 42.

The binary image 41 is an example of bitmap data expressing a rectangular figure. The multi-value image 42 is an example of bitmap data expressing a photograph of a copy machine. The multi-value image 42 is a photographic image but it is schematically shown in FIG. 2.

The input document data 40 shown in FIG. 2 is generated in accordance with a command set 43 shown in FIG. 3.

The command set 43 shown in FIG. 3 includes a command 44 and a command 45. The command 44 is a command to draw the binary image 41. The command 45 is a command to draw the multi-value image 42.

In the command 44, the number of bits “1”, the decoding filter indicating the difference in image coding method “CCITTFaxDecode”, and the color “Gray” are described as attribute information of the bitmap data.

Meanwhile, in the command 45, the number of bits “8”, the decoding filter indicating the difference in image coding method “DCTDecode”, and the color “RGB” are described as attribute information of the bitmap data.

Next, a case will be described in which document data in a format that the electronic file name of bitmap data is designated, as in HTML or XML, is inputted.

FIG. 4 is a view showing an example of HTML input document data including two bitmap data. FIG. 5 is a view showing an exemplary command set to draw each bitmap data of the input document data shown in FIG. 4.

Input document data 50 in a format that the electronic file name of bitmap data is designated, shown in FIG. 4, includes two bitmap data, that is, a binary image 51 and a multi-value image 52.

The binary image 51 is an example of bitmap data expressing a rectangular figure. The multi-value image 52 is an example of bitmap data expressing a photograph of a copy machine. The multi-value image 52 is a photographic image but it is schematically shown in FIG. 4.

The input document data 50 shown in FIG. 4 is generated in accordance with a command set 53 shown in FIG. 5.

The command set 53 shown in FIG. 5 includes a command 54 and a command 55. The command 54 is a command to draw the binary image 51. The command 55 is a command to draw the multi-value image 52.

In the command 54, “gif” is described as an extension of the electronic file of the bitmap data to be inserted. It can be understood that the binary image 51 has the GIF format.

Meanwhile, in the command 55, “jpg” is described as an extension of the electronic file of the bitmap data to be inserted. It can be understood that the multi-value image 52 has the JPEG format.

The determining unit 13 compares attribute information of each bitmap data of the inputted first document data with an attribute of predetermined attribute information and determines whether the bitmap data is convertible into vector data or not.

Specifically, the determining unit 13 first searches the attribute information of each bitmap data of the inputted first document data, and then compares the searched attribute information with an attribute of predetermined attribute information to determines whether the bitmap data is convertible into vector data or not.

As techniques of comparing the searched attribute information with an attribute of predetermined attribute information, for example, comparing the number of bits, comparing the image coding method, comparing the extension of electronic file name and so on may be employed. These techniques will be described below.

First, the technique of comparing the number of bits in the case where document data having a format that the number of bits of bitmap data is directly written is inputted, will be described.

For example, the determining unit 13 searches a command to draw bitmap data of the first document data, and if the searched command has the number of bits equal to or less than a predetermined number of bits, the determining unit 13 determines that the bitmap data is convertible into vector data. On the other hand, if the searched command has the number of bits that exceeds the predetermined number of bits, the determining unit 13 determines that the bitmap data is inconvertible into vector data.

The predetermined number of bits can be suitably set, for example, 8 bits as the total number of bits. In the case where the predetermined number of bits is 8 bits as the total number of bits, since the binary image 41 is created by the command 44 having the number of bits “1” and the color “Gray”, the total number of bits of the binary image 41 is 1 bit and it is determined that the binary image 41 is convertible into vector data.

Meanwhile, in the case where the predetermined number of bits is 8 bits as the total number of bits, since the multi-value image 42 is created by the command 45 having the number of bits “8” and the color “RGB”, the total number of bits of the multi-value image 42 is 24 bits and it is determined that the multi-value image 42 is inconvertible into vector data.

Next, the technique of comparing the image coding method in the case where document data having a format that the image coding method of bitmap data is directly written is inputted, will be described.

For example, the determining unit 13 searches a command to draw bitmap data of the first document data, and if the searched command has a predetermined image coding method, the determining unit 13 determines that the bitmap data is convertible into vector data. On the other hand, if the searched command does not have the predetermined image coding method, the determining unit 13 determines that the bitmap data is inconvertible into vector data.

The predetermined image coding method can be suitably set. For example, “CCITTFaxDecode” is set as the decoding filter of the image coding method with which the bitmap data is determined as being convertible into vector data.

In this case, since the binary image 41 is created by the command 44 having the decoding filter “CCITTFaxDecode”, it corresponds to the predetermined image coding method and it is determined that the binary image 41 is convertible into vector data.

Meanwhile, since the multi-value image 42 is created by the command 45 having the decoding filter “DCTDecode”, it does not correspond to the predetermined image coding method and it is determined that the multi-value image 42 is inconvertible into vector data.

Moreover, the technique of comparing the extension in the case where document data having a format that the electronic file name of bitmap data is designated is inputted, will be described.

For example, the determining unit 13 searches the extension of the electronic file name of a command to draw bitmap data of the first document data, and if the searched extension is a predetermined extension, the determining unit 13 determines that the bitmap data is convertible into vector data. On the other hand, if the searched extension is not the predetermined extension, the determining unit 13 determines that the bitmap data is inconvertible into vector data.

The predetermined extension can be suitably set. For example, the extension of the GIF format, the extension of the MMR format, the extension of the JBIG2 format, the extension of the Windows Bitmap format, and the extension of the PNG format are set as the extensions with which the bitmap data is determined as being convertible into vector data.

In the case where bitmap data is in the Windows Bitmap format or PNG format, it is impossible to determine whether the bitmap data represents a multi-value image or an index color, only on the basis of the expression of the extension of the electronic file name of the command to draw the bitmap data.

However, since information about whether the bitmap data represents a multi-value image or an index color is described in the header of the command, it is possible to determine whether the bitmap data represents a multi-value image or a index color by referring to the description of the header as well as the extension of the electronic file name of the command.

In this case, for example, the determining unit 13 searches the content of the header of a command to draw bitmap data of the first document data as well as the extension of the electronic file name of the command to draw the bitmap data of the first document data. If the searched content of the header is a predetermined header content, the determining unit 13 determines that the bitmap data is convertible into vector data. On the other hand, if the searched content of the header is not the predetermined header content, the determining unit 13 determines that the bitmap data is inconvertible into vector data.

The predetermined header content can be suitably set. For example, the information of index color described in the header can be set as the header content with which the bitmap data is determined as being convertible into vector data, and the information of multi-value image described in the header can be set as the header content with which the bitmap data is determined as being inconvertible into vector data.

In the case where bitmap data is in the MMR format or JBIG2 format, since MMR and JBIG2 are image coding systems that handle binary images, each of these formats is usually set as being convertible into vector data.

Moreover, in the case where bitmap data is in the GIF format, Windows Bitmap format, or PNG format, since GIF, Windows Bitmap and PNG are image coding systems that handle index images, each of these formats is usually set as being convertible into vector data.

For example, in the case where the predetermined extension is the extension of the GIF format, since the binary image 51 is created by the command 54 having the extension of the electronic file name “gif”, which is the extension of the GIF format, it corresponds to the predetermined extension and it is determined that the binary image 51 is convertible into vector data.

Meanwhile, since the multi-value image 52 is created by the command 55 having the extension of the electronic file name “jpg”, which is the extension of the JPEG format, it does not correspond to the predetermined extension and it is determined that the multi-value image 52 is inconvertible into vector data.

The selector 14 separates the bitmap data that is determined as being convertible into vector data by the determining unit 13 and the bitmap data that is determined as being inconvertible into vector data or document data other than bitmap data.

The bitmap data that is determined as being convertible into vector data is sent to the vectorizing unit 15. The bitmap data that is determined as being inconvertible into vector data or the document data is sent to the component recombining unit 16.

The vectorizing unit 15 converts the bitmap data that is determined as being convertible into vector data by the determining unit 13, into vector data.

As a technique of converting into vector data, a known technique, for example, the method described in JP-A-2005-182369 can be employed.

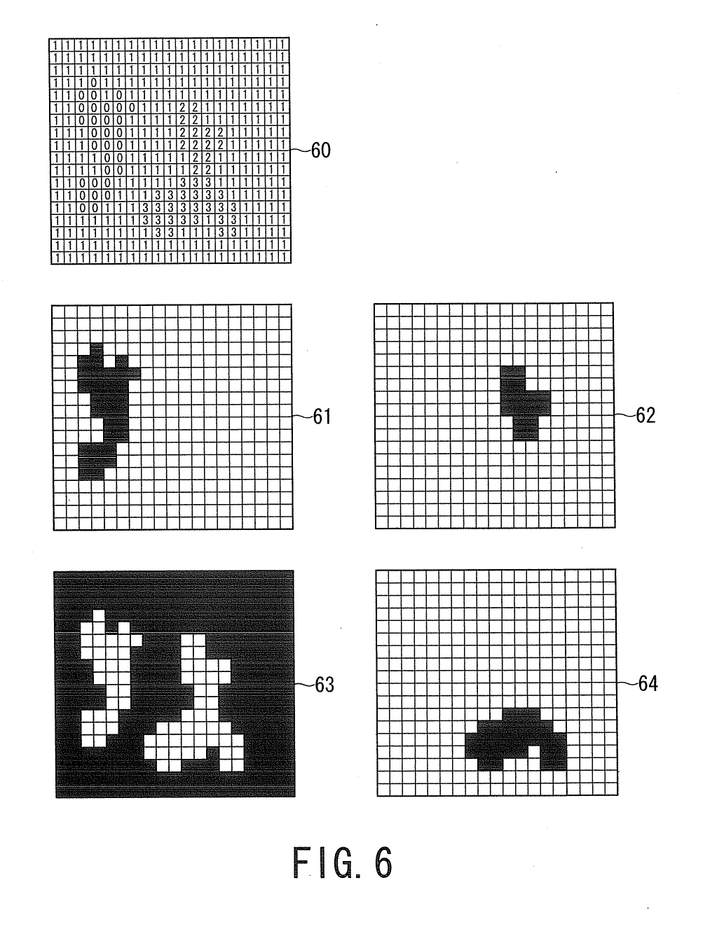

In the method described in JP-A-2005-182369, an input is limited to a binary image. Therefore, in the case of converting a multi-value image that exceed a binary value into vector data, this multi-value image is separated to create a binary image and then converted into vector data. For example, in the case of converting a four-color index image into vector data, four binary images 61 to 64 are created from an input image 60, as shown in FIG. 6, and each of the binary images 61 to 64 is vectorized.

The component recombining unit 16 combines image data that is converted into vector data, image data that is not converted into vector data, and document data other than image data, which are acquired by dividing the first document data into components, and thus creates second document data. Known means can be used as the component recombining unit 16.

An example of second document data including image data that is converted into vector data and image data that is not converted into vector data will be described with reference to the drawings.

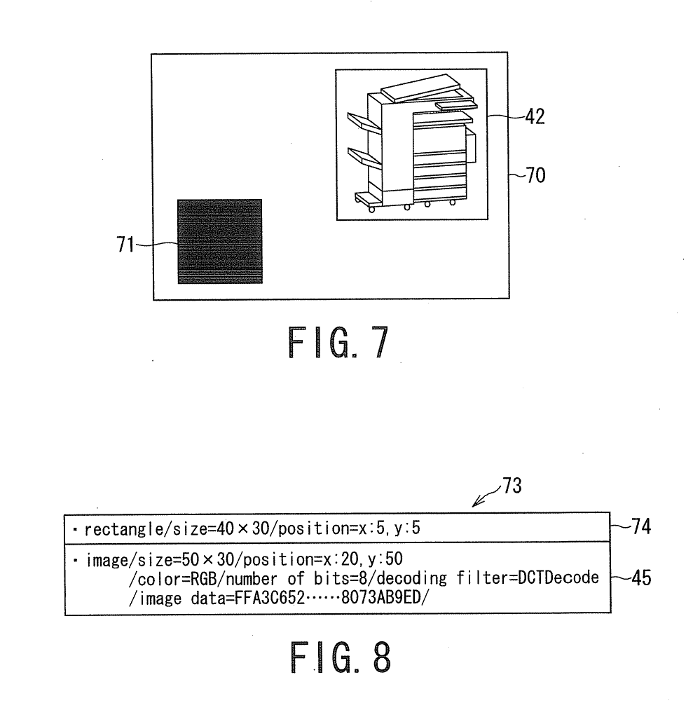

FIG. 7 is a view showing second document data acquired by converting a part of the bitmap data of the input document data shown in FIG. 2, into a vector data. FIG. 8 is a view showing an exemplary command set to draw the vector data and each bitmap data of the document data shown in FIG. 7.

Second document data 70 shown in FIG. 7 includes a binary image 71 and a multi-value image 42.

The binary image 71 is an example of vector data expressing a rectangular figure as a result of converting the binary image 41 shown in FIG. 2 into vector data.

The multi-value image 42 is the same as the bitmap data included in the input document data 40 shown in FIG. 2.

A command set 73 shown in FIG. 8 includes a command 74 and a command 45. The command 74 is a command to draw the binary image 71. The command 45 is a command to draw the multi-value image 42.

The command 74 shown in FIG. 8 has a different content from the command 44 shown in FIG. 3.

That is, “image” is described and also the number of bits, color and so on are described in the command 44 because the binary image 41 to be drawn is bitmap data, whereas “rectangle” instead of “image” is described in the command 74 and no color or the like is described therein because the binary image 71 to be drawn is vector data.

Besides, the command 45 is the same as the command 45 shown in FIG. 3 since the multi-value image 42 to be drawn has not been converted into vector data and remains as the bitmap data included in the input document data 40 shown in FIG. 2.

The output unit 21 outputs the second document data. For example, a known printer is used as the output unit 21.

To print the created document data, the image data is usually converted into the page description language (PDL) by a printer driver.

Since information to discriminate whether the image data included in the document data is in the format of bitmap data or vector data can be described in the PDL of the created document data, it is possible to determine the format of the image data and perform processing suitable for the format of the image data at the time of printing.

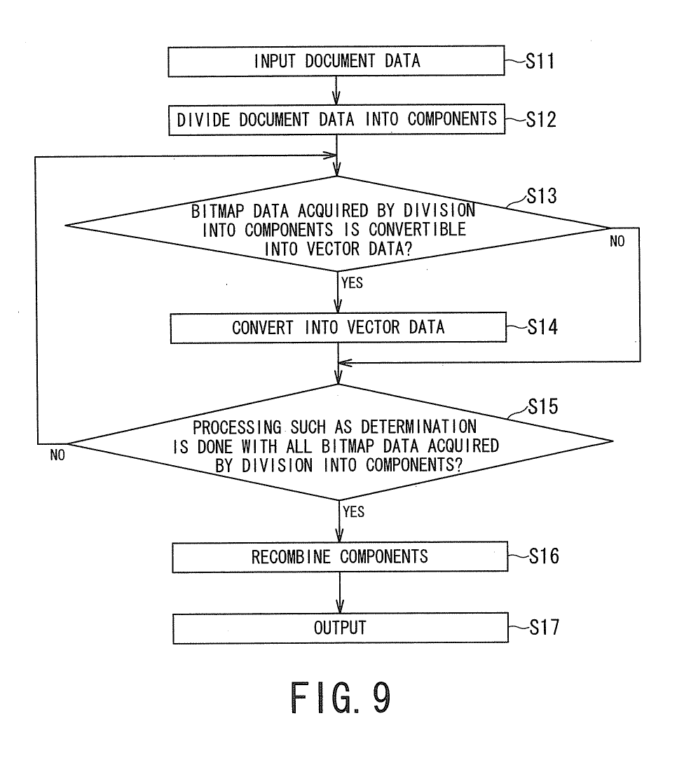

Next, the operation of the image processing apparatus 1 according to the invention will be described. FIG. 9 is a flowchart showing the operation of the image processing apparatus 1 according to the invention.

As an input step, document data including one or two or more bitmap data is inputted (step S11).

As an image component division step, the inputted first document data is divided into components and bitmap data included in the first document data is separated (step S12). For example, in the case where two bitmap data and one document data are included in the first document data, the first document data is separated into the two bitmap data and the one document data in the image component division step.

As a determination step, if attribute information of each bitmap data acquired by the division into components corresponds to an attribute of predetermined attribute information, the bitmap data is determined as being convertible into vector data, and if the attribute information of the bitmap data does not correspond to an attribute of the predetermined attribute information, the bitmap data is determined as being inconvertible into vector data (step S13).

Whether the attribute information of each bitmap data acquired by the division into components corresponds to an attribute of the predetermined attribute information or not is determined by searching the attribute information of each bitmap data acquired by the division into components and determining whether the searched attribute information corresponds to an attribute of the predetermined attribute information or not.

In the determination step (step S13), specifically, the bitmap data is separated from the inputted first document data, and a command to draw each bitmap data is searched. If the number of bits of the bitmap data to be drawn in accordance with the searched command is equal to or less than a predetermined number of bits, the bitmap data can be determined as being convertible into vector data. If the searched command has the number of bits exceeding the predetermined number of bits, the bitmap data can be determined as being inconvertible into vector data.

Also, in the determination step (step S13), specifically, the bitmap data is separated from the first document data, and a command to draw each bitmap data is searched. If the image coding method of the bitmap data to be drawn in accordance with the searched command is a predetermined image coding method, the bitmap data can be determined as being convertible into vector data. If the image coding method of the bitmap data to be drawn in accordance with the searched command is not the predetermined image coding method, the bitmap data can be determined as being inconvertible into vector data.

Moreover, in the determination step (step S13), specifically, the bitmap data is separated from the inputted first document data, and the extension of the electronic file name of bitmap data to be drawn in accordance with a command to draw each bitmap data is searched. If the searched extension is a predetermined extension, the bitmap data can be determined as being convertible into vector data. If the searched extension is not the predetermined extension, the bitmap data can be determined as being inconvertible into vector data.

As a vectorization step, the bitmap data determined as being convertible into vector data in the determination step is converted into vector data (step S14).

The above step S13 and step S14 are repeated until the processing is completed with all the bitmap data acquired by the division into components (step S15).

As a component recombination step, the image data converted into vector data, the image data that have not been converted into vector data, and document data other than the image data are combined to create second document data (step S16).

As an output step, the second document data is outputted to a printer and so on (step S17).

The advantages of the image processing apparatus 1 and the image processing method using the image processing apparatus 1 will be described.

With the image processing apparatus 1 and the image processing method using the image processing apparatus 1, even in the case where all document data are command data expressing bitmaps, whether the bitmap data can be vectorized or not is determined in accordance with the number of bits, the coding method of the bitmap data and so on, and the bitmap data can be converted into vector data. As a result, an output with high image quality can be provided at the time of enlarging or reducing a monitor output or print output of binary bitmap data or index bitmap data. Moreover, since image processing can be switched in accordance with image attributes in the case of a printer output, a printer output with high image quality can be provided.

Particularly, there has recently been a technique in which an input document is identified by area so that characters are binarized and then compressed by MMR coding whereas natural images are JPEG-compressed, thus expressing a high-compressed document with high image quality of the characters maintained. With the image processing apparatus 1, the characters in such an expression method can be expressed with higher image quality.

### Second Embodiment

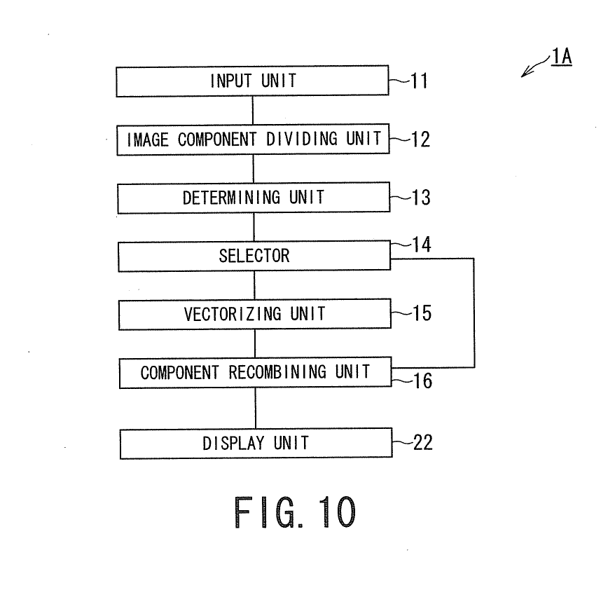

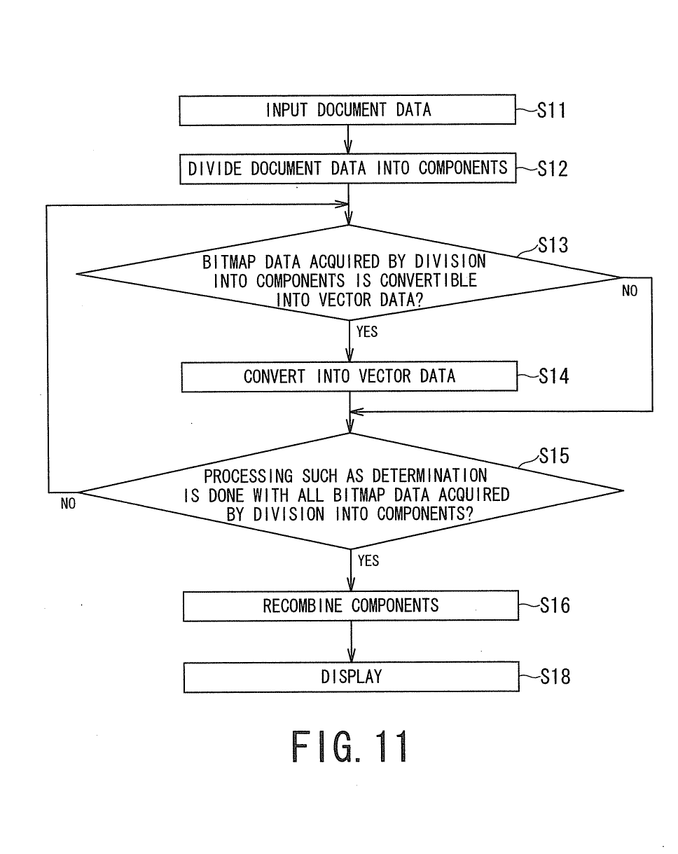

Next, the second embodiment of the image processing apparatus according to the invention will be described with reference to FIG. 10 and FIG. 11.

An image processing apparatus 1A described in the second embodiment differs from the image processing apparatus 1 described in the first embodiment in that the output unit 21 is replaced by a display unit 22. As the other parts of the configuration and operations are not different from those of the image processing apparatus 1 described in the first embodiment, the same members are denoted by the same reference numerals and the description of these members is simplified or omitted.

FIG. 10 is a functional block diagram of the image processing apparatus 1A according to the invention.

The display unit 22 displays second document data. For example, a known liquid crystal display, plasma display, CRT or the like is used as the display unit 22.

Next, the operation of the image processing apparatus 1A according to the invention will be described. FIG. 11 is a flowchart showing the operation of the image processing apparatus 1 and the image processing apparatus 1A according to the invention.

The image processing apparatus 1A carries out steps S11 to S16 similarly to the image processing apparatus 1, and then carries out a display step.

In the display step, the second document data is displayed on a liquid crystal display, plasma display, CRT and so on (step S18).

The advantages of the image processing apparatus 1A and the image processing method using the image processing apparatus 1A will be described.

With the image processing apparatus 1A and the image processing method using the image processing apparatus 1A, even in the case where all document data are command data expressing bitmaps, whether the bitmap data can be vectorized or not is determined in accordance with the number of bits and the coding method of the bitmap data, and the bitmap data can be converted into vector data. As a result, an output with high image quality can be provided at the time of enlarging or reducing a monitor output or print output of binary bitmap data or index bitmap data. Moreover, since image processing can be switched in accordance with image attributes in the case of a printer output, a printer output with high image quality can be provided.

Particularly, there has recently been a technique in which an input document is identified by area so that characters are binarized and then compressed by MMR coding whereas natural images are JPEG-compressed, thus expressing a high-compressed document with high image quality of the characters maintained. With the image processing apparatus 1A, the characters in such an expression method can be expressed with higher image quality.

Moreover, unlike the image processing apparatus 1, the image processing apparatus 1A simply displays the second document data instead of printing. Therefore, it is not necessary to convert the second document data into PDL.

In the case of printing the saved second document data by using an output unit, not shown, it is possible to determine the format of image data and perform processing suitable for the format of the image data at the time of printing, as in the image processing apparatus 1.

What is claimed is:

1. An image processing apparatus comprising:
an input unit configured to input first document data including one or two or more bitmap data;
an image component dividing unit configured to divide the inputted first document data into components and separate the bitmap data included in the first document data;
a determining unit configured to determine, in the case where attribute information of each bitmap data acquired by the division into components corresponds to an attribute of predetermined attribute information, that the bitmap data is convertible into vector data; and
a vectorizing unit configured to convert the bitmap data that is determined as being convertible into vector data, into vector data.

2. The image processing apparatus according to claim 1, wherein the determining unit searches a command to draw each bitmap data acquired by the division into components, and determines that the bitmap data is convertible into vector data in the case where the searched command has a number of bits equal to or less than a predetermined number of bits.

3. The image processing apparatus according to claim 1, wherein the determining unit searches a command to draw each bitmap data acquired by the division into components, and determines that the bitmap data is convertible into vector data in the case where the searched command has a predetermined image coding method.

4. The image processing apparatus according to claim 1, wherein the determining unit searches an extension of an electronic file name of a command to draw each bitmap data acquired by the division into components, and determines that the bitmap data is convertible into vector data in the case where the searched extension is a predetermined extension.

5. The image processing apparatus according to claim 1, further comprising a component recombining unit configured to combine image data that is converted into vector data, image data that is not converted into vector data, and document data, to create second document data.

6. The image processing apparatus according to claim 5, further comprising an output unit configured to output the second document data.

7. The image processing apparatus according to claim 5, further comprising a display unit configured to display the second document data.

8. An image processing method comprising:
inputting first document data including one or two or more bitmap data;
dividing the inputted first document data into components and separating the bitmap data included in the first document data;
in the case where attribute information of each bitmap data acquired by the division into components corresponds to an attribute of predetermined attribute information, determining that the bitmap data is convertible into vector data; and
converting the bitmap data that is determined as being convertible into vector data, into vector data.

9. The image processing method according to claim 8, wherein the determination includes searching a command to draw each bitmap data acquired by the division into components, and determining that the bitmap data is convertible into vector data in the case where the searched command has a number of bits equal to or less than a predetermined number of bits.

10. The image processing method according to claim 8, wherein the determination includes searching a command to draw each bitmap data acquired by the division into components, and determining that the bitmap data is convertible into vector data in the case where the searched command has a predetermined image coding method.

11. The image processing method according to claim 8, wherein the determination includes searching an extension of an electronic file name of a command to draw each bitmap data acquired by the division into components, and determining that the bitmap data is convertible into vector data in the case where the searched extension is a predetermined extension.

12. An image processing method comprising:
inputting first document data including one or two or more bitmap data;
dividing the inputted first document data into components and separating the bitmap data included in the first document data;
in the case where attribute information of each bitmap data acquired by the division into components corresponds to an attribute of predetermined attribute information, determining that the bitmap data is convertible into vector data;
converting the bitmap data that is determined as being convertible into vector data, into vector data; and
combining image data that is converted into vector data, image data that is not converted into vector data, and document data, to create second document data.

13. The image processing method according to claim 12, wherein the determination includes searching a command to draw each bitmap data acquired by the division into components, and determining that the bitmap data is convertible into vector data in the case where the searched command has a number of bits equal to or less than a predetermined number of bits.

14. The image processing method according to claim 12, wherein the determination includes searching a command to draw each bitmap data acquired by the division into components, and determining that the bitmap data is convertible into vector data in the case where the searched command has a predetermined image coding method.

15. The image processing method according to claim 12, wherein the determination includes searching an extension of an electronic file name of a command to draw each bitmap data acquired by the division into components, and determining that the bitmap data is convertible into vector data in the case where the searched extension is a predetermined extension.

16. The image processing method according to claim 12, further comprising outputting the second document data.

17. The image processing method according to claim 12, further comprising displaying the second document data.
